(19) United States
(12) Patent Application Publication
(10) Pub. No.: US 2026/0246293 A1
(43) Pub. Date: Aug. 20, 2026

(54) Discharge System and Method for Discharging at Least One Electric Storage Unit

(71) Applicant: Siemens Aktiengesellschaft, München (DE)

(72) Inventors: Sascha Schulte, Höchstadt (DE); Sebastian Taubensee, Markkleeberg (DE)

(73) Assignee: Siemens Aktiengesellschaft, München (DE)

(21) Appl. No.: 18/846,864

(22) PCT Filed: Mar. 2, 2023
(86) PCT No.: PCT/EP2023/055335

§ 371 Date: Sep. 13, 2024

(30) Foreign Application Priority Data
Mar. 18, 2022 (EP) 22162998.3
Mar. 31, 2022 (EP) 22165759.6

(51) Int. Cl. H02J 7/96; H02J 7/70; H02J 7/82

(52) U.S. Cl. CPC H02J 7/96; H02J 7/751; H02J 7/82; H02J 2207/50

(57) ABSTRACT

Various embodiments of the teachings herein include a method for discharging accumulators or supercapacitors. An example includes: loading an accumulator or supercapacitor into a storage device receiving unit forming an electric circuit to discharge the accumulator or supercapacitor; discharging them, wherein the discharge current is controlled via a control device; ascertaining the voltage of an individual accumulator or supercapacitor using a sensor and ascertaining an exchange value for an accumulator or supercapacitor in the computing unit; and removing a discharged accumulator or supercapacitor from the associated storage device receiving unit as soon as the exchange value assumes a Remove value, wherein the electric circuit is maintained via the parallel-connected diode following said removal. The exchange value assumes the value Remove for a voltage in a range from more than 0 V to 0.5 V.

### CROSS-REFERENCE TO RELATED APPLICATIONS

This application is a U.S. National Stage Application of International Application No. PCT/EP2023/055335 filed Mar. 2, 2023, which designates the United States of America, and claims priority to EP Application No. 22165759.6 filed Mar. 31, 2022, and EP Application No. 22162998.3 filed Mar. 18, 2022 the contents of which are hereby incorporated by reference in their entirety.

### TECHNICAL FIELD

The present disclosure relates to electric storage. Various embodiments of the teachings herein include systems and/or methods for discharging at least one electric storage unit.

### BACKGROUND

The recycling of used electric energy storage devices, in particular rechargeable battery storage devices, is increasingly important for the sake of sustainable commerce. The rejects that are produced during battery manufacture may also be recycled for the sake of sustainable commerce. In order to safely recycle the energy storage devices, the defective or used energy storage devices must be discharged so that further processing steps can be safely performed.

At present, for the purpose of discharging, many storage cells are connected together in series to form a network. In this case, each storage cell typically has a cell voltage in a range from 3 V to 4 V. Said network containing 100s of volts is then discharged using a standard voltage system converter. Before the discharging process, the storage cells have various charge states depending on their prior use. Consequently, at a constant rate of discharge, the individual storage cells have a sufficiently low residual voltage at different points in time. As soon as said sufficiently low residual voltage is reached, this storage cell should be removed from the network in order to prevent negative recharging and hence also a safety-critical state, in particular fire risk.

It is disadvantageous that withdrawal must therefore be rapid in order to ensure a safe discharge. Furthermore, the discharging process is interrupted when a storage cell is withdrawn from the network. This clearly delays the discharging of the remaining network.

### SUMMARY

The teachings disclosure include discharge systems and methods for discharging electric storage devices, which allow faster and safer discharging in comparison with the prior art. For example, some embodiments of the teachings herein include a discharge system (1) for accumulators (10) or supercapacitors, comprising: a control device (3) comprising a power source and a computing unit, a discharge unit (7) comprising at least one storage device receiving unit (2) suitable for receiving and electrically contacting an accumulator or supercapacitor, a diode (5) which is arranged in parallel with the storage device receiving unit (2) and in a reverse direction relative to a stored voltage of the accumulator (10) or supercapacitor in a normal installation direction of the storage device receiving unit, wherein at least two discharge units (7) are arranged in series, and an electric circuit is formed for the purpose of discharging via the control device (3), the inserted accumulators (10) or supercapacitors and the storage device receiving unit (2); wherein at least one sensor unit (4) is provided for ascertaining the voltage of each individual accumulator (10) or supercapacitor that is inserted into the storage device receiving unit (2), wherein the control device (3) is connected in series with the series-connected discharge units (7), wherein the computing unit is designed to ascertain an exchange value for the accumulator (10) or supercapacitor; wherein the storage device receiving unit (2) allows removal of a discharged accumulator (10) or supercapacitor from the associated storage device receiving unit (2) as soon as the exchange value assumes a Remove value, wherein the electric circuit is maintained via the parallel-connected diode (5) following said removal; wherein the computing unit is additionally designed to ascertain the exchange value such that it assumes the value Remove for a voltage in a range from more than 0 V to 0.5 V, in particular more than 0 V to 0.3 V, as measured by the sensor unit (4).

In some embodiments, the storage device receiving unit (2) has a clamping terminal, clips or screw terminal for mechanically fixing and electrically connecting the accumulator (10) or supercapacitor.

In some embodiments, the sensor unit (4) is integrated into the control device (3) or the discharge unit (7).

As another example, some embodiments include a method for discharging at least two accumulators (10) or supercapacitors, comprising: providing a discharge system (1) as claimed in the preceding claims, loading an accumulator (10) or supercapacitor into the storage device receiving unit (2), wherein an electric circuit is formed for the purpose of discharging via the control device (3), the accumulators (10) or supercapacitors and the storage device receiving unit (2), discharging the accumulators (10) and/or supercapacitors, wherein the discharge current is controlled via the control device (3), ascertaining the voltage of the individual accumulator (10) or supercapacitor by means of a sensor unit (4) and ascertaining an exchange value for an accumulator (10) or supercapacitor in the computing unit, and removing a discharged accumulator (10) or supercapacitor from the associated storage device receiving unit (2) as soon as the exchange value assumes a Remove value, wherein the electric circuit is maintained via the parallel-connected diode (5) following said removal; wherein the exchange value assumes the value Remove for a voltage in a range from more than 0 V to 0.5 V, in particular more than 0 V to 0.3 V, as measured by the sensor unit (4).

In some embodiments, an individual storage cell or a parallel network of at least two storage cells is used as an accumulator (10).

In some embodiments, the control device (3) is operated with a current of at least 10 A and/or a power of at least 100 W.

In some embodiments, the exchange value assumes the value either Discharge or Remove for an accumulator (10) or supercapacitor.

In some embodiments, the control device (3) interrupts the current flow if a voltage of less than 0 V is ascertained by the sensor unit (4).

In some embodiments, the insertion and removal of the accumulator (10) or supercapacitor takes place automatically, in particular by means of a robot.

In some embodiments, at least one supercapacitor and one accumulator are discharged simultaneously.

### BRIEF DESCRIPTION OF THE DRAWINGS

Further features, properties, and advantages of the teachings of the present disclosure are revealed in the following description with reference to the appended figures, in which:

FIG. 1 shows an example discharge system incorporating teachings of the present disclosure with three accumulators during the discharging process;

FIG. 2 shows an Example Discharge System Incorporating teachings of the present disclosure with two accumulators during the discharging process; and

FIG. 3 schematically shows a diagram of an example method incorporating teachings of the present disclosure for discharging at least two accumulators.

### DETAILED DESCRIPTION

The present disclosure describes discharge system for accumulators or supercapacitors comprising a control device. The control device comprises a power source and a computing unit. The discharge system further comprises a discharge unit, which comprises at least one storage device receiving unit that is suitable for receiving and electrically contacting an accumulator or a supercapacitor. The discharge unit further comprises a diode which is arranged in parallel with the storage device receiving unit, and which is arranged in a reverse direction relative to a stored voltage of the accumulator or supercapacitor in a normal installation direction of the storage device receiving unit. At least two discharge units are arranged in series. Furthermore, the discharge system comprises at least one sensor unit for ascertaining the voltage of each accumulator or supercapacitor that is inserted in the storage device receiving unit. The control device is connected in series with the series-connected discharge units.

Some embodiments include methods for discharging at least two accumulators or supercapacitors. An accumulator or supercapacitor is loaded into the storage device receiving unit, whereby an electric circuit is formed for the purpose of discharging via the control unit, the accumulators or supercapacitors and the storage device receiving unit. The discharging of the accumulators or supercapacitors then takes place, the discharge current being controlled via the control device. The voltage of the individual accumulators or supercapacitors is ascertained by means of a sensor unit. On the basis of this, an exchange value for an accumulator or supercapacitor is ascertained in the computing unit. As soon as the exchange value assumes a Remove value for an accumulator or supercapacitor, this accumulator or supercapacitor is removed from the associated storage device receiving unit, the electric circuit being maintained via the parallel-connected diode following said removal.

The discharge systems and methods allow the discharging of a multiplicity of accumulators or supercapacitors having non-uniform charge states at the beginning of the discharging process. These accumulators or supercapacitors may be discharged simultaneously, it being possible to exchange an individual accumulator or supercapacitor in the discharge system during the discharging process. Dead times of the discharge system, which would be necessary without the use of the diode, may be avoided thereby. In other words, it is possible to discharge a multiplicity of accumulators and/or supercapacitors simultaneously on an industrial scale and thereby prepare them for subsequent processing.

Accumulators are rechargeable electric galvanic storage units. An alternative designation is rechargeable battery storage devices.

The control device is a controllable power unit. Expressed otherwise, the computing unit is understood to be the controller which decides how much power is required.

The diode is appropriately able to continuously carry the current of the whole series in a forward direction. The reverse voltage should appropriately correspond to at least the voltage of an accumulator or supercapacitor.

Leakage currents through the diodes are possible, but these do not adversely affect the discharge system or the method for discharging.

In some embodiments, the storage device receiving unit has a clamping terminal, clips or a screw terminal for mechanically fixing and electrically connecting the accumulator or supercapacitor. This allows the accumulator or supercapacitor to be securely connected to the storage device receiving unit, thereby ensuring a safe discharge of the accumulators or supercapacitors.

In some embodiments, the sensor unit is integrated into the control device or the discharge unit. The structure of the discharge system is advantageously simplified thereby.

In some embodiments, an individual storage cell or a parallel network of at least two storage cells is used as an accumulator. In other words, it is possible to discharge different accumulators in the discharge system. In particular, either used accumulators are prepared for a recycling process or rejects from battery production are discharged in order to be reused likewise.

In some embodiments, the control device is operated using a current of at least 10 A and/or a power of at least 100 W. It is possible to use standard industrial voltage system converters which work in a range from 300 V to 800 V. It is then possible in particular to simultaneously discharge 100 to 200 storage cells in series.

In some embodiments, the exchange value assumes the value either Discharge or Remove for an accumulator or supercapacitor in each case. In other words, there are two exchange values, one for Discharge and one for Remove. These two exchange values are not output literally by the computing unit but can also be ascertained and output by the computing unit using numerical values of a binary system or using other words or symbols. By means of the exchange value, it is therefore possible either for a user to exchange the accumulator or supercapacitor or for an automated system to intervene in order to exchange the accumulator or supercapacitor. The evaluation of the voltage takes place in the computing unit using predetermined limit values.

In some embodiments, the exchange value assumes the value Remove for a voltage in a range from more than 0 V to 0.3 V as measured by the sensor unit. In this range, the accumulators or supercapacitors are sufficiently discharged to be recycled. However, they are not discharged in such a way that a negative voltage occurs, which could lead to dangerous fires in the discharge system.

In some embodiments, the exchange value assumes the value Remove for a voltage in a range from 1.9 V to 2.1 V, particularly preferably 2 V, as measured by the sensor unit. For the extraction of raw materials in particular, a voltage in a range from 1.9 V to 2.1 V, e.g. 2 V, may be surprisingly particularly advantageous.

In some embodiments, the control device interrupts the current flow if a voltage of less than 0 V is ascertained for an accumulator or supercapacitor by the sensor unit. The occurrence of processes which represent a safety risk in the discharge system, in particular fire, may be prevented thereby. The safety of the discharge system may be increased significantly thereby.

In some embodiments, the insertion and removal of the accumulator or supercapacitor is automated, in particular by means of a robot. It is thereby possible to discharge a multiplicity of accumulators or supercapacitors simultaneously without requiring the intervention of a skilled operator.

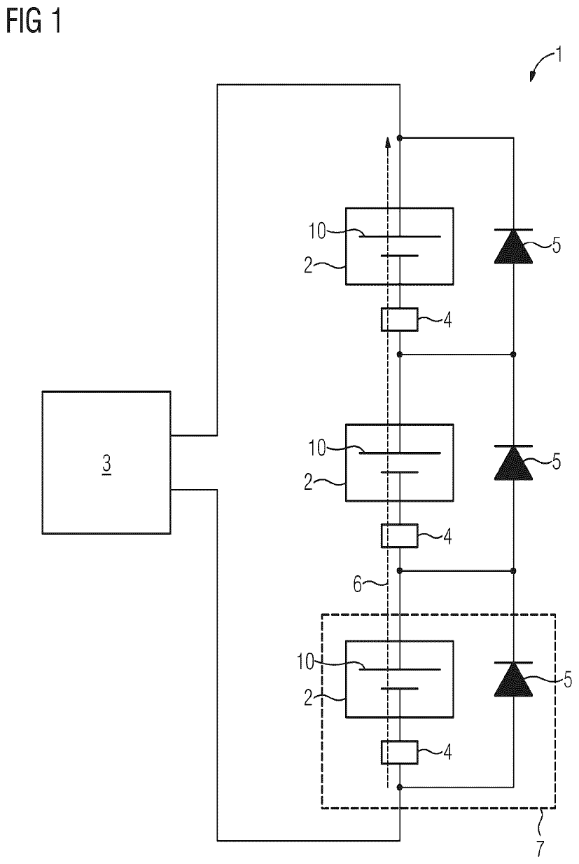

FIG. 1 shows an example discharge system 1 incorporating teachings of the present disclosure with three storage device receiving units 2, a control device 3, three sensor units 4 and three diodes 5. The current flow 6 takes place via the three accumulators (10) that are arranged for discharging in the storage device receiving units 4. The control device monitors the current flow. The sensor units 4 monitor the voltage of the individual accumulators (10). On the basis of the voltage that is ascertained, the computing unit, which is integrated in the control device 3 in this example, ascertains an exchange value for the respectively monitored accumulators (10). If the voltage for one of the accumulators (10) lies in a range from 0 V to 0.3 V, the exchange value assumes the value Remove. The discharged accumulator (10) is then withdrawn from the discharge system 1 by a skilled operator or automatically by a robot.

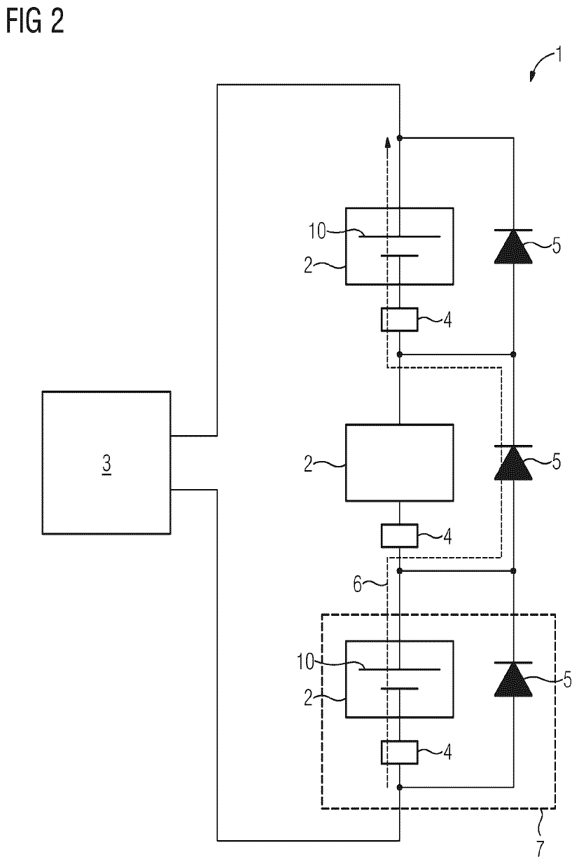

FIG. 2 shows the discharge system 1 with three storage device receiving units 2, two accumulators 10 being arranged in two storage device receiving units 2. No accumulator is arranged for discharging in the central storage device receiving unit 2 illustrated in FIG. 2. The current flow 6 now takes place via the two accumulators 10 in the respective storage device receiving units 2 and via the diode 5 that is arranged in parallel with the storage device receiving unit 2 in which no accumulator 10 is arranged.

If an accumulator 10 is now inserted into the central storage device receiving unit 2 again, either automatically or by means of a skilled operator, the current flow 6 again takes place as illustrated in FIG. 1 via the three storage device receiving units 2 with the accumulators 10.

An alternative solution would be to configure switches instead of the diodes. The bridging of the open contacts by means of switches may be disadvantageous because the switch must be switched with a dead time for the purpose of removing the battery and therefore the risk of a short circuit is present. The use of the diodes therefore supports the safe and continuous operation of the discharge system.

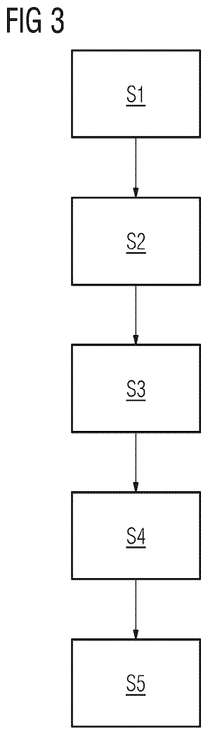

FIG. 3 shows a diagram of an example method incorporating teachings of the present disclosure for discharging accumulators. In S1, a discharge system 1 is provided. In S2, an accumulator 10 is loaded into the storage device receiving unit 2, whereby an electric circuit is formed for the purpose of discharging via the control unit 3, the accumulators 10 and the storage device receiving unit 4. The discharging of the accumulators 10 takes place in S3, the discharge current being controlled via the control device 3. In S4, the voltage of the individual accumulator 10 is ascertained by means of a sensor unit 4. Furthermore, an exchange value for an accumulator 10 is ascertained in the computing unit. In S5 following thereupon, at least one discharged accumulator 10 is removed from the associated storage device receiving unit 2 as soon as the exchange value assumes a value Remove, the electric circuit being maintained via the parallel-connected diode following said removal.

### LIST OF REFERENCE SIGNS

1 Discharge system
2 Storage device receiving unit
3 Control device
4 Sensor unit
5 Diode
6 Current flow
7 Discharge unit
10 Accumulator
S1 Providing a discharge system
S2 Loading an accumulator into the storage device receiving unit
S3 Discharging the accumulators
S4 Ascertaining the voltage of individual accumulators and ascertaining an exchange value
S5 Removing a discharged accumulator

What is claimed is:

1. A discharge system for accumulators or supercapacitors, the system comprising:
a control device having a power source and a computing unit;
a discharge unit including a storage device receiving unit for receiving and electrically contacting at least two accumulators and/or supercapacitors, a diode arranged in parallel with the storage device receiving unit and in a reverse direction relative to a stored voltage of the at least two accumulators and/or supercapacitors in a normal installation direction of the storage device receiving unit;
wherein at least two discharge units are arranged in series, and an electric circuit is formed for the purpose of discharging via the control device, the inserted accumulators or supercapacitors and the storage device receiving unit; and
a sensor for ascertaining the voltage of each individual accumulator or supercapacitor inserted into the storage device receiving unit;
wherein the control device is connected in series with the series-connected discharge units;
wherein the computing unit ascertains an exchange value for each accumulator or supercapacitor;
wherein the storage device receiving unit allows removal of a discharged accumulator or supercapacitor from the associated storage device receiving unit as soon as the exchange value assumes a Remove value;
wherein the electric circuit is maintained via the parallel-connected diode following said removal;
wherein the computing unit ascertains the exchange value such that it assumes the value Remove for a voltage in a range from more than 0 V to 0.5 V.

2. The discharge system as claimed in claim 1, wherein the storage device receiving unit includes a clamping terminal, clips, or screw terminal for mechanically fixing and electrically connecting an accumulator or supercapacitor.

3. The discharge system as claimed in claim 1, wherein the sensor unit 4 is integrated into the control device or the discharge unit.

4. A method for discharging accumulators and/or supercapacitors, the method comprising:
loading at least two accumulators and/or supercapacitors into a storage device receiving unit forming an electric circuit to discharge the at least two accumulators and/or supercapacitors;
discharging the at least two accumulators and/or supercapacitors, wherein the discharge current is controlled via a control device;
ascertaining the voltage of an individual accumulator or supercapacitor using a sensor and ascertaining an exchange value for the individual accumulator or supercapacitor in the computing unit; and
removing a discharged accumulator or supercapacitor from the associated storage device receiving unit as soon as the exchange value assumes a Remove value, wherein the electric circuit is maintained via the parallel-connected diode following said removal;
wherein
the exchange value assumes the value Remove for a voltage in a range from more than 0 V to 0.5 V.

5. The method as claimed in claim 4, wherein an accumulator includes an individual storage cell or a parallel network of at least two storage cells.

6. The method as claimed in claim 4, wherein the control device operates with a current of at least 10 A and/or a power of at least 100 W.

7. The method as claimed in claim 4, wherein the exchange value assumes the value either Discharge or Remove for an accumulator or supercapacitor.

8. The method as claimed in claim 4, wherein the control device interrupts the current flow if a voltage of less than 0 V is ascertained by the sensor.

9. The method as claimed in claim 8, wherein the insertion and removal of the accumulator or supercapacitor takes place automatically.

10. The method as claimed in claim 4, wherein at least one supercapacitor and one accumulator are discharged simultaneously.
